(19) United States
(12) Patent Application Publication
(10) Pub. No.: US 2018/0299837 A1
(43) Pub. Date: Oct. 18, 2018

(54) ANTENNA ARRANGEMENT FOR AN ELECTRONIC DEVICE AND AN ELECTRONIC DEVICE INCLUDING SAME

(71) Applicant: Timex Group USA, Inc., Middlebury, CT (US)

(72) Inventors: Ronald J. DeRosa, New Haven, CT (US); Shruthi Soora, Durham, NC (US); Koichiro Takamizawa, Silver Spring, MD (US)

(21) Appl. No.: 15/953,654

(22) Filed: Apr. 16, 2018

Related U.S. Application Data
(60) Provisional application No. 62/486,620, filed on Apr. 18, 2017.

(51) Int. Cl. G04G 21/04; H01Q 1/24; H01Q 1/27; G04R 60/06; H01Q 7/00

(52) U.S. Cl. CPC G04G 21/04; H01Q 1/243; H01Q 7/005; G04R 60/06; H01Q 1/273

(57) ABSTRACT

A wristworn device including a radio communication device for at least one of receiving signals from and transmitting signals to a communication device external to the wristworn device, the wristworn device including a non-electrically conductive watchcase that itself has an outer surface, a crystal that seals a first end of the watchcase and a case back that seals a second end of the watchcasing; an antenna structure comprising an outer conductive layer and an internal conductive layer electrically coupled to the outer conductive layer; a controller disposed in the casing of the watchcase and operatively coupled to the radio communication device, and wherein the outer conductive layer is electrically coupled to the radio communication device, and the outer conductive layer together with the inner conductive layer function as the antenna for at least one of reception or transmission of signals for the radio communication device. In the disclosed embodiments, the outer conductive layer is preferably disposed on the outer surface of the non-electrically conductive watchcase or embedded within the watchcase.

### BACKGROUND OF THE INVENTION

The present invention relates generally to antennas, and in particular, to an improved antenna for a wristworn device having signal transmitting and/or receiving capabilities. In exemplary embodiments, the wristworn device is a timepiece such as a wristwatch, but, as will become quite clear below, a timepiece or wristwatch is only by way of example and not limitation. In particular, the invention is primarily directed to improved signal transmission and reception utilizing a non-electrically conductive watchcasing that has been provided with an antenna structure comprising a conductive layer embedded therein or provided thereon.

The prior art is full of examples of antennas associated with wristworn devices, such as wristwatches. For example, U.S. Pat. Nos. 5,072,231; 6,104,354; 6,028,555 and 6,154,177 are but just a few examples of devices incorporating loop antennas for signal reception and transmission. Although the use of loop antennas for signal reception and transmission has been found to be particularly desirable in timepieces, the use thereof in a timepiece comprised of a metal case has been found to have drawbacks and to be less than optimal, typically because of the poor performance due to the shielding of the antenna by the metal case itself. Additionally, electro-static discharge (ESD) is also a known problem when using a metal casing.

The present inventor already on at least one occasion has overcome the aforementioned deficiencies by way of the invention disclosed in U.S. Pat. No. 7,215,600, in which desirable signal reception and transmission thereof has been achieved with the use of a metal casing functioning as the antenna. The subject matter of U.S. Pat. No. 7,215,600 is incorporated by reference herein in its entirety.

However and notwithstanding the improved results provided by the embodiments set forth in the aforementioned '600 patent, further improvements are desirable. For example, it would be desirable to achieve at least all of the objectives and advantages set forth in U.S. Pat. No. 7,215,600 while using a non-electrically conductive watchcase.

### OBJECTIVES AND SUMMARY OF THE INVENTION

Therefore, it is generally an object and advantage of the present invention to provide an improved antenna structure for a device comprising a non-electrically conductive watchcasing.

It is still a further object and advantage of the present invention to provide an improved antenna structure for a wristworn device having improved signal transmission and reception functionality.

It is another object and advantage of the present invention to provide an improved antenna structure for a wristworn timepiece that incorporates therein a receiver, transmitter and/or transceiver.

It is yet another object of the present invention is to provide an improved antenna structure for a wristworn device that reduces the number of components of the device yet provides satisfactory or even improved signal reception and/or transmission.

Yet another object and advantage of the present invention is to provide an improved antenna structure that reduces ESD.

Still another object and advantage of the present invention is to achieve all of the advantages and objectives as set forth in U.S. Pat. No. 7,215,600 while using a non-electrically conductive watchcase.

For example, it is an objective and advantage of the present invention to provide a wristworn device, including but not limited to a timepiece, that includes an improved antenna structure as disclosed herein.

Further objects and advantages of this invention will become more apparent from a consideration of the drawings and ensuing description.

The invention accordingly comprises the features of construction, combination of elements, arrangement of parts and methodology of construction that will be exemplified in the disclosure hereinafter set forth, and the scope of the invention will be indicated in the claims.

To overcome the perceived deficiencies in the prior art and to achieve the objects and advantages above and below, the present invention, generally speaking, in a first embodiment is directed to a wristworn device comprising a radio communication device for at least one of receiving signals from and transmitting signals to a communication device external to the wristworn device, the wristworn device comprising a non-electrically conductive watchcase that itself has an outer surface, a crystal that seals a first end of the watchcase and a case back that seals a second end of the watchcasing; an antenna structure comprising a conductive layer disposed on the outer surface of the non-electrically conductive watchcase and an internal conductive layer electrically coupled to the outer conductive layer; a controller disposed in the casing of the watchcase and operatively coupled to the radio communication device, and wherein the outer conductive layer is electrically coupled to the radio communication device, and the outer conductive layer together with the inner conductive layer function as the antenna for at least one of reception or transmission of signals for the radio communication device.

In another preferred embodiment, the invention is directed to a wristworn device comprising a radio communication device for at least one of receiving signals from and transmitting signals to a communication device external to the wristworn device, the wristworn device comprising a non-electrically conductive watchcase, a crystal that seals a first end of the watchcase and a case back that seals a second end of the watchcasing; an antenna structure comprising an outer conductive layer embedded within the watchcase and an internal conductive layer electrically coupled to the outer conductive layer; a controller disposed in the casing and operatively coupled to the radio communication device, and wherein the outer conductive layer is electrically coupled to the radio communication device, and the outer conductive layer together with the inner conductive layer together function as the antenna for at least one of reception or transmission of signals for the radio communication device.

In a specific preferred embodiment, the device is a wristworn device and in a more specific preferred embodiment the wristworn device is a timepiece.

### BRIEF DESCRIPTION OF THE DRAWINGS

The above set forth and other features of the invention are made more apparent in the ensuing Description of the Preferred Embodiments when read in conjunction with the attached Drawings, wherein:

FIG. 1 is an exploded perspective view of the present invention in accordance with a first embodiment of the present invention;

FIG. 2 is an exploded perspective view of the present invention in accordance with a second embodiment of the present invention, while FIG. 2A is a cross-section of a portion of the watchcase of FIG. 2 to exemplary show the outer conductive layer embedded therein; and

FIG. 3 is an exploded perspective view showing other features of the present invention, including for example and not limitation, a digital display and separate display hands for a separate analog display, each display separately and/or together being incorporated into the embodiments of FIGS. 1 and/or 2.

Like reference numbers are used for like parts, although not every feature is numbered in each figure.

### DETAILED DESCRIPTION OF THE PREFERRED EMBODIMENTS

Reference shall be first made generally to the Figures and the following disclosure, which depicts and discloses a wristworn device, generally indicated at 10, constructed in accordance with preferred embodiments of the present invention.

In a preferred embodiment, device 10 is a wristworn device, and preferably a timepiece. However, as indicated above, device 10 need not be limited to a timepiece or wristwatch, and may be a variety of other devices, such as a heart rate monitor, glucose monitor or other communication device, examples of which are disclosed in Published Application Serial No. 2004/0233788 (the '788 Published Application), which is hereby incorporated by reference in its entirety.

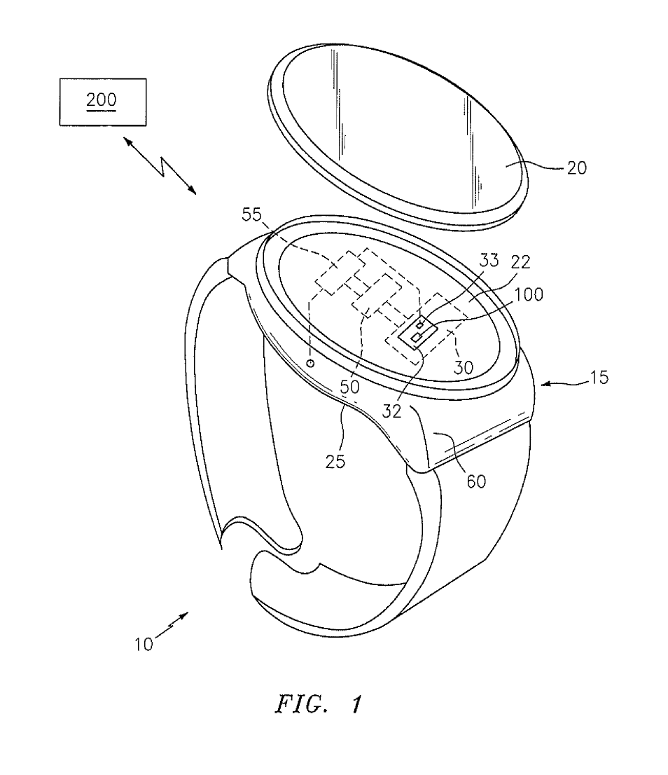

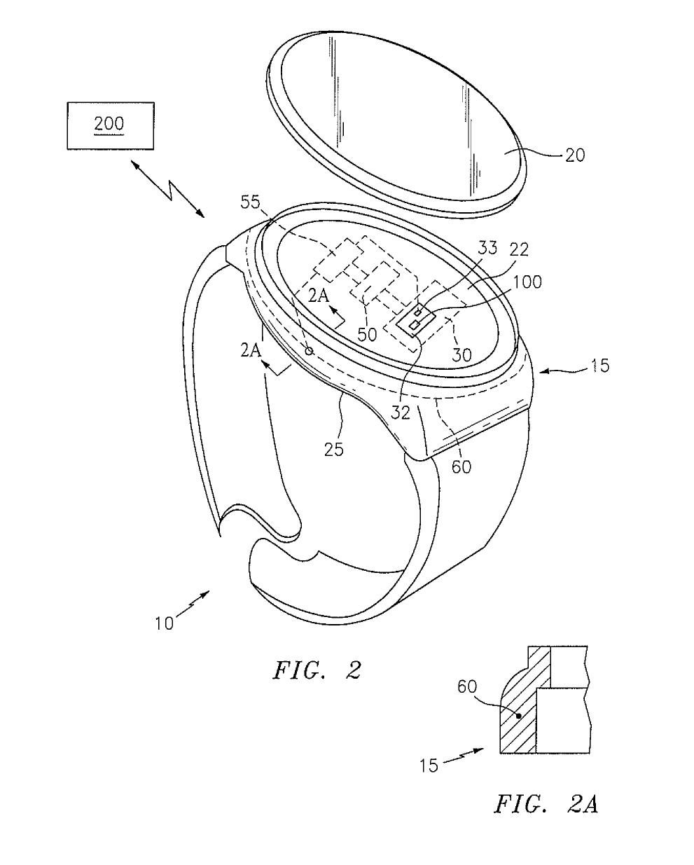

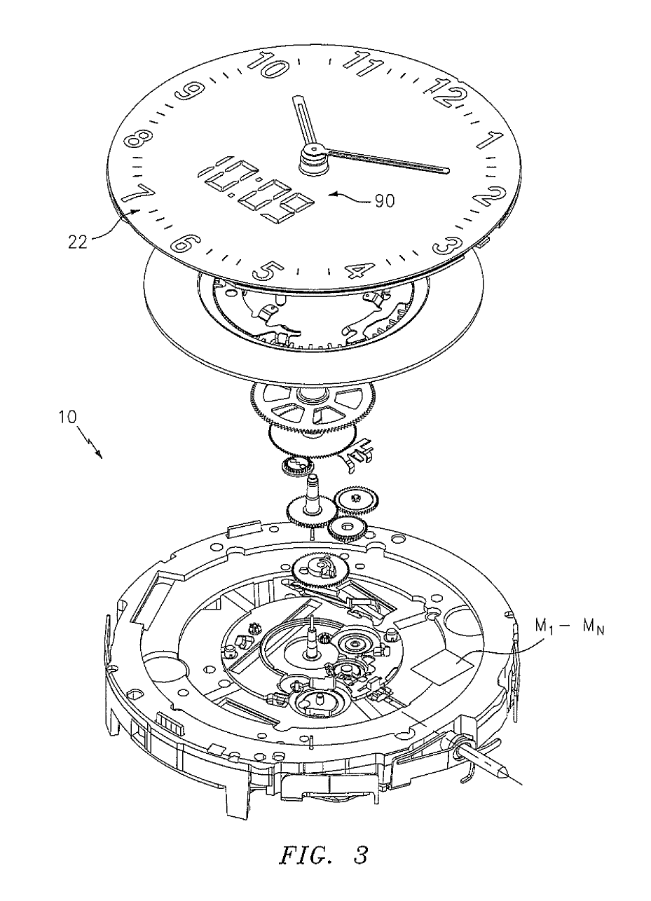

As illustrated in FIGS. 1 and 2, device 10 preferably comprises a non-electrically conductive watchcase 15, a glass or plastic transparent watch crystal 20 that allows viewing of a watch dial 22, a case back 25 and a watch movement, generally also referred to as controller 30, which contains the electrical and mechanical mechanisms for timekeeping, including hand movement. For example, a plastic watchcase surely meets the definition of non-electrically conductive watchcase. A battery (not shown) is also provided. Watch dial 22 provides for the display of information in an analog or digital fashion (e.g. see FIG. 3). As will be true for all the figures, it should be apparent that dial 22 is “under” the crystal 20 and that controller 30 (i.e. the movement) is preferably “under” the dial 22.

As disclosed in the aforementioned U.S. Pat. No. 7,215,600, reference(s) cited therein and in FIG. 3 herein, an “analog fashion” of display typically comprises the use of hands, while a “digital fashion” display (e.g. generically indicated at 90) typically consists of an LED, LCD, a dot matrix or a variety of the new display technologies that display information without the use of actual/physical indicator hands.

As is also well-known in the art, controller/movement 30 for device 10 (e.g. a watch movement”) preferably comprises a printed circuit board 32 that may contain thereon a microcontroller 100 (similar to controller 100 in the aforementioned '788 published application), and/or discrete semiconductor devices and/or an application specific integrated circuit (ASIC) to perform timekeeping and communications functions. Controller/movement 30 may also comprise one or more (e.g. stepping) motors (see generically indicated at M₁-Mₙ in FIG. 3) for the rotation of the indicator (e.g. hour/minute, display) hands. Similarly, the controller or “movement” 30 may comprise digital display functionality for the display of data on dial 22 in a “digital fashion” format 90. In either “movement,” a frame is provided to hold the entire structure together as one unit. Disclosure of a suitable controller, microcontroller and other hand movement components for the present invention is provided in U.S. Pat. No. 7,215,600 and the aforementioned '788 published application, the subject matter of both documents being incorporated by reference herein in their entireties. To be clear, the term “controller” is intended to comprehensively encompass all the circuitry, software and hardware to communicate with the communication device 50 which will be hereinafter disclosed, which in turn communicates with the external communication device, generally indicated at 200, and as disclosed in the aforementioned U.S. Pat. No. 7,215,600. Moreover, the “controller” is intended to also include all the hand rotation signaling and functionality to carry out the objectives set forth herein and made apparent hereby.

In accordance with the present invention, device 10 comprises a radio communication device, generally indicated at 50, such as a transmitter, a receiver and/or a transceiver. Communication device 50 may be mounted on the printed circuit board or other suitable location within watchcase 15 and preferably interfaces to the microcontroller 100 of controller 30. Data is transferred to or from radio communication device 50 for the purpose of data display, data storage and/or control, all as is well known in the art.

In accordance with the present invention, watchcase 15 is preferably, but not necessarily, a continuous non-electrically conductive shell, such as plastic or ceramic. Watchcase 15 may be circular or square, by way of example and not limitation.

As illustrated in FIG. 1 in particular, an outer conductive layer, generally indicated 60, is provided on the outer surface of the watchcase 15, and preferably at least extends around the perimeter of the watchcase 15. If watchcase 15 includes a slot, then outer conductive layer 60 terminates at the slot. As will be understood by those skilled in the art, this outer metallic layer 60 acts as a radiator for electromagnetic energy. Preferably, conductive layer 60 is a layer of metallic paint, laser direct structuring (LDS), a solid metallic or partitioned foil, or a solid or partitioned piece of metal. Furthermore, preferably layer 60 covers the entire surface of the selected section of the watchcase, but covering of less than an entire surface is contemplated hereby. For example, in a preferred embodiment, conductive layer 60 is confined to the upper part of the watchcase, as illustrated in FIG. 1, but it is possible and within the scope of the invention that the conductive layer 60 extends and is applied over the entire surface of the watchcase 15.

FIG. 2 illustrates an alternative embodiment in which the outer conductive layer 60 may be embedded in the non-conductive watchcase 15, having been positioned therein during the molding process of watchcase 15 (e.g. see FIG. 2A). Similarly, outer conductive layer 60 may be a layer of metallic paint, laser direct structuring (LDS), a solid metallic or partitioned foil, or a solid or partitioned piece of metal. Here too, outer conductive layer 60 preferably at least extends around the perimeter of the watchcase 15. If watchcase 15 includes a slot, then outer conductive layer 60 similarly terminates at the slot.

In accordance with all the preferred embodiments herein, radio communications device 50 is preferably coupled to a matching network 55 consisting of inductors and/or capacitors as would be understood in the art. Matching network 55 itself is electrically coupled between outer conductive layer 60 and a ground plane 33 of the PC board 32. By optimum selection of the inductors and/or capacitors of matching network 55 at the frequency or range of frequencies at which communications device 50 operates, watchcase 15 becomes an electric field type loop antenna, all of which can be maximized by the selection of the components of matching network 55. As should now be understood, excitation occurs to the antenna structure between the PC board ground plane 33 and the outer conductive layer 60 in both embodiments of FIGS. 1 and 2.

The loop configuration created by the antenna structure comprising outer conductive layer 60, the inner conductive layer preferably comprising the ground plane 33 of the PC board 32, and matching network 55 creates a form factor that efficiently radiates energy and receives radiated energy. The unique approach with the preferred embodiments of the present invention is the optimum match of communications device 50 to outer conductive layer 60, which becomes the radiating element.

As would be understood by those skilled in the art, metal in proximity of outer conductive layer 60 can affect the ability of the antenna's performance. And, since any deviation from the loop form factor such as the addition of a metal case back would detract from the loop's ability to radiate waves or receive radiated waves, case back 25 is comprised of a form factor that maintains the loop configuration. This is achieved most easily by using a non-electrically conductive case back such as glass, ceramic and/or plastic which does not significantly impede radiation. It can also be comprised of a nonmetallic material in the center of the case back and a metallic material on the perimeter of the case back, effectively maintaining the loop configuration. Here again, dial 22 is preferably configured from non-conductive material to minimize any negative effects to transmission or reception.

It should also be understood however that the incorporation of matching network 55 is somewhat optional, as the antenna structure can also be left unmatched depending on the desired antenna characteristics particular for each design.

It can thus be seen that the present invention provides an improved antenna structure for a wristworn device having improved signal transmission and reception functionality utilizing a non-electrically conductive watchcase that has been provided with an outer metallic layer 60 that acts as a radiator for electromagnetic energy, wherein the conductive layer 60 is preferably a layer of metallic paint, laser direct structuring (LDS), a solid metallic or partitioned foil, or a solid or partitioned piece of metal on the surface of the watchcase or alternatively, the outer conductive layer 60 may be embedded in the non-electrically conductive watchcase 15.

It will thus be seen that the objects set forth above, among those made apparent from the preceding description, are efficiently attained and, since certain changes may be made in the above constructions without departing from the spirit and scope of the invention, it is intended that all matter contained in the above description or shown in the accompanying drawings shall be interpreted as illustrative and not in a limiting sense. It is also to be understood that the following claims are intended to cover all of the generic and specific features of the invention described herein and all statements of the scope of the invention which as a matter of language might fall therebetween.

1. A wristworn device comprising a radio communication device for at least one of receiving signals from and transmitting signals to a communication device external to the wristworn device, the wristworn device comprising:
a non-electrically conductive watchcase that itself has an outer surface, a crystal that seals a first end of the watchcase and a case back that seals a second end of the watchcasing;
an antenna structure comprising a conductive layer disposed on the outer surface of the non-electrically conductive watchcase and an internal conductive layer electrically coupled to the outer conductive layer;
a controller disposed in the casing of the watchcase and operatively coupled to the radio communication device, and
wherein the outer conductive layer is electrically coupled to the radio communication device, and
the outer conductive layer together with the inner conductive layer function as the antenna for at least one of reception or transmission of signals for the radio communication device.

2. A wristworn device comprising a radio communication device for at least one of receiving signals from and transmitting signals to a communication device external to the wristworn device, the wristworn device comprising:
a non-electrically conductive watchcase, a crystal that seals a first end of the watchcase and a case back that seals a second end of the watchcasing;
an antenna structure comprising an outer conductive layer embedded within the watchcase and an internal conductive layer electrically coupled to the outer conductive layer;
a controller disposed in the casing and operatively coupled to the radio communication device, and
wherein the outer conductive layer is electrically coupled to the radio communication device, and
the outer conductive layer together with the inner conductive layer together function as the antenna for at least one of reception or transmission of signals for the radio communication device.

3. The wristworn device as claimed in claim 1, wherein the inner conductive layer is a ground plane of a PC board.

4. The wristworn device as claimed in claim 2, wherein the inner conductive layer is a ground plane of a PC board.

5. The wristworn device as claimed in claim 1, wherein the outer conductive layer comprises metallic paint, laser direct structuring (LDS), a solid metallic or partitioned foil, or a solid or partitioned piece of metal.

6. The wristworn device as claimed in claim 1, comprising a display, operatively coupled to the controller, for displaying information based on the signals received from the radio communications device.

7. The wristworn device as claimed in claim 1, wherein the antenna structure is tuned to a selected frequency.

8. The wristworn device as claimed in claim 1, wherein the antenna structure is tuned to a range of frequencies.

9. The wristworn device as claimed in claim 1, wherein the antenna structure is left un-tuned.

10. The wristworn device as claimed in claim 1, wherein the case back is selected from the group consisting of a ferrous metal, a non-ferrous metal, a nonmetal, or a combination of metal and nonmetal.

11. The wristworn device as claimed in claim 6, wherein the display comprises a dial assembly and one or more display hands, wherein the dial assembly is comprised of conductive or non-electrically conductive materials.

12. The wristworn device as claimed in claim 1, comprising one or more switches for interfacing with the controller for entering data into or configuring operation of the controller.

13. The wristworn device as claimed in claim 2, wherein the outer conductive layer comprises metallic paint, laser direct structuring (LDS), a solid metallic or partitioned foil, or a solid or partitioned piece of metal,

14. The wristworn device as claimed in claim 2, comprising a display, operatively coupled to the controller, for displaying information based on the signals received from the radio communications device.

15. The wristworn device as claimed in claim 2, wherein the antenna structure is tuned to a selected frequency.

16. The wristworn device as claimed in claim 2, wherein the antenna structure is tuned to a range of frequencies.

17. The wristworn device as claimed in claim 2, wherein the antenna structure is left un-tuned.

18. The wristworn device as claimed in claim 2, wherein the case back is selected from the group consisting of a ferrous metal, a non-ferrous metal, a nonmetal, or a combination of metal and nonmetal.

19. The wristworn device as claimed in claim 14, wherein the display comprises a dial assembly and one or more display hands, wherein the dial assembly is comprised of conductive or non-electrically conductive materials.

20. The wristworn device as claimed in claim 2, comprising one or more switches for interfacing with the controller for entering data into or configuring operation of the controller.
